(19) United States
(12) Patent Application Publication
(10) Pub. No.: US 2010/0266343 A1
(43) Pub. Date: Oct. 21, 2010

(54) MIXTURE FOR PREVENTING CONTAMINANT DIFFUSION AND METHOD FOR PREVENTING CONTAMINANT DIFFUSION

(75) Inventor: Koji Takahashi, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: NIPPON SHEET GLASS COMPANY, LIMITED, Tokyo (JP)

(21) Appl. No.: 12/742,054

(22) PCT Filed: Sep. 19, 2008
(86) PCT No.: PCT/JP2008/066990

§ 371 Date: May 7, 2010

(30) Foreign Application Priority Data
Nov. 8, 2007 (JP) 2007-290429

(51) Int. Cl. B09C 1/00; B01J 20/06; B01J 20/22

(52) U.S. Cl. 405/129.85; 502/400; 502/401

(57) ABSTRACT

It is to provide a mixture for preventing contaminant diffusion having stable and excellent purifying ability against a contaminant included in contaminated soil as compared to the conventional technique for preventing contaminant diffusion, and a method for preventing contaminant diffusion. The mixture for preventing contaminant diffusion is comprised of an adsorbing agent for adsorbing a contaminant included in contaminated soil and a diluent mixed at a predetermined ratio to the adsorbing agent for adjusting permeability coefficient and thickness, wherein a spatial velocity of water containing the contaminant is 1 to 60 (1/hr).

### TECHNICAL FIELD

This invention relates to a mixture for preventing contaminant diffusion used for purifying sewage containing a contaminant(s) and a method for preventing contaminant diffusion by disposing a layer made of the mixture for preventing contaminant diffusion between contaminated soil and non-contaminated soil, and purifying the contaminant in sewage passed through the contaminated soil to discharge into the non-contaminated soil.

### BACKGROUND ART

Heretofore, as a method for treating soil containing a contaminant such as arsenic or the like are used in-situ insolubilization measures wherein an agent for insolubilizing the contaminant is injected or inject-agitated into a distribution range of contaminated soil to decrease an amount of the contaminant eluted from the contaminated soil (soil eluted amount), seepage control containment measures wherein the contaminated soil is removed by excavation and the contaminated soil is covered with a seepage control sheet for keeping out water or the like and thereafter the contaminated soil is again filled therein to thereby prevent the contaminated soil from contacting with groundwater and the contaminant from eluting, and so on as disclosed in Non-patent Document 1.

In the in-situ insolubilization measures, however, pH and redox potential of soil, coexistent ion type, ion-exchange capacity of soil and the like are varied by the injection of the agent, and as a result, there are a fear that a contaminant other than the components to be insolubilized, for example, a contaminant such as lead or the like is eluted when pH rises, and a fear that hexavalent chromium elutes from cement itself used as an auxiliary agent for insolubilization, and further there are problems that since a greater amount of the agent is required and also the agitation with the contaminated soil is necessary, the cost is increased and the workability is poor. In the seepage control containment measures, there is a problem that since it is required to provide a seepage control sheet of an extremely large size for covering the whole of the contaminated soil, the cost is increased, and there is a fear that since the seepage control sheet is mainly made from an organic material, it is broken to elute a contaminant from the broken portion.

Thus, as the method for treating the contaminated soil is not currently existent a simple method for preventing the contaminant contained in sewage passed through the contaminated soil from intruding into an adjacent non-contaminated soil without requiring a large amount of the agent as in the in-situ insolubilization measure.

In addition, as a method for purifying groundwater other than the above-mentioned soil-treating method, there are a structure for purifying groundwater wherein a wall-shaped zone made from a material containing iron powder and the like is provided in the ground as disclosed in Patent Document 1, and a method for purifying contaminated groundwater wherein a groundwater purifying zone containing a purifying agent made by forming a hydroxide or oxide of rare-earth metal on a surface of zeolite is provided as disclosed in Patent Document 2.

However, in the groundwater-purifying structure of Patent Document 1, there is a fear that since arsenic contained in the groundwater is passivated into a form of metallic arsenic in the purifying zone instead of adsorption, the passivated metallic arsenic is again discharged into non-contaminated soil associated with decrease in pH and redox potential of soil. And also, in the method for purifying contaminated groundwater of Patent Document 2, there is a problem that since an advanced technique for precipitating the hydroxide or oxide of rare-earth metal on the zeolite surface is used, the cost of the adsorbing agent is increased to thereby increase the construction cost. Moreover, the groundwater purifying techniques of Patent Documents 1 and 2 have problems that rationalization on water permeability of the purifying zone is not sufficient, and the purifying ability on the contaminant is insufficient, and the stability is lacking.

Non-patent Document 1: Geo-Environmental Protection Center, “Description on Technical Method of Research and Measure Based on Soil Contamination”, Geo-Environmental Protection Center, Japan, September 2003, p 102-123

Patent Document 1: JP-A-2003-39080

Patent Document 2: JP-A-2005-334749

### DISCLOSURE OF THE INVENTION

It is, therefore, an object of the invention to provide a mixture for preventing contaminant diffusion, which has a stable and excellent purifying ability on a contaminant included in contaminated soil by rationalizing a spatial velocity, and a method for preventing contaminant diffusion.

The inventors have made various studies on a mixture for preventing contaminant diffusion and a method for preventing contaminant diffusion in order to solve the above problems. As a result, it has been found that by adjusting permeability coefficient and thickness of the mixture for preventing contaminant diffusion (or a contaminant diffusion preventing layer) to render a spatial velocity into 1-60 (1/h) is made a contact time between an adsorbing agent in the mixture for preventing contaminant diffusion (contaminant diffusion preventing layer) and the contaminant to a proper range, and the discharge of the contaminant into a non-contaminated soil due to the shorter contact time but also stagnation of water in the mixture (layer) due to the longer contact time can be prevented, and hence the excellent purifying ability can be developed stably.

The invention is based on such knowledge and the summary is as follows.

(1) A mixture for preventing contaminant diffusion, characterized in that the mixture is constituted with an adsorbing agent for adsorbing the contaminant included in contaminated soil and a diluent mixed at a predetermined ratio to the adsorbing agent for adjusting permeability coefficient and thickness and a spatial velocity of water containing the contaminant is 1 to 60 (1/hr).

(2) The mixture for preventing contaminant diffusion according to the item (1), wherein the adsorbing agent contains at least a rare earth compound.

(3) The mixture for preventing contaminant diffusion according to the item (2), wherein the rare earth compound is one or more rare earth compounds selected from cerium hydroxide, cerium oxide, lanthanum hydroxide, lanthanum oxide and a hydrate thereof.

(4) The mixture for preventing contaminant diffusion according to any one of the items (1) to (3), wherein the adsorbing agent contains one or more components selected from Al, Fe, Si, P, Ca and Mg.

(5) The mixture for preventing contaminant diffusion according to any one of the items (1) to (4), wherein the diluent is an inorganic material, an inorganic fiber material, an organic material or an organic fiber material.

(6) The mixture for preventing contaminant diffusion according to any one of the items (1) to (5), wherein a volume ratio of the adsorbing agent to the diluent is 0.001 to 2.

(7) The mixture for preventing contaminant diffusion according to any one of the items (1) to (6), wherein the contaminant is arsenic or antimony, and the spatial velocity is 20-40 (1/hr).

(8) The mixture for preventing contaminant diffusion according to any one of the items (1) to (6), wherein the contaminant is lead or chromium, and the spatial velocity is 1-15 (1/hr).

(9) The mixture for preventing contaminant diffusion according to any one of the items (1) to (6), wherein the contaminant is fluorine, and the spatial velocity is 5-20 (1/hr).

(10) The mixture for preventing contaminant diffusion according to any one of the items (1) to (6), wherein the contaminant is selenium or boron, and the spatial velocity is 1-10 (1/hr).

(11) The mixture for preventing contaminant diffusion according to any one of the items (1) to (6), wherein the contaminant is mercury, and the spatial velocity is 1-5 (1/hr).

(12) A method for preventing contaminant diffusion, which comprises disposing a contaminant diffusion preventing layer having a water permeability and a predetermined thickness between contaminated soil and non-contaminated soil for adsorbing a contaminant included in the contaminated soil, and adsorbing and holding the contaminant by the contaminant diffusion preventing layer when sewage flowing in the contaminated soil passes through the contaminant diffusion preventing layer.

(13) The method for preventing contaminant diffusion according to the item (12), wherein the contaminant diffusion preventing layer is constituted with a mixture of an adsorbing agent for adsorbing a contaminant produced from contaminated soil and a diluent mixed at a predetermined ratio to the adsorbing agent for adjusting permeability coefficient and thickness, and a spatial velocity of water containing the contaminant in the mixture is 1-60 (1/hr).

(14) The method for preventing contaminant diffusion according to the item (12) or (13), wherein the contaminant diffusion preventing layer has a permeability coefficient of 1×10⁻³ to 10 cm/sec and a thickness of 0.1 to 10 m.

(15) The method for preventing contaminant diffusion according to any one of the items (12) to (14), wherein the contaminant is one or more components selected from arsenic, fluorine, boron, selenium, lead, chromium, cadmium, manganese, antimony and nickel.

(16) The method for preventing contaminant diffusion according to any one of the items (12) to (15), wherein the contaminant diffusion preventing layer is formed by mixing the adsorbing agent with the diluent and then further mixing with a diluent same as or different from the above diluent so as to evenly arrange the adsorbing agent and the diluent.

(17) The method for preventing contaminant diffusion according to any one of the items (13) to (16), wherein a content of the adsorbing agent is determined based on results of an acid-added elution test and an alkali-added elution test.

### BRIEF DESCRIPTION OF THE DRAWINGS

FIG. 1 is a view schematically showing a method for preventing contaminant diffusion according to the invention;

FIG. 2 is a view schematically showing a state of embedding a contaminant diffusion preventing layer according to the invention in the ground for use, wherein (a) shows a case of disposing the contaminant diffusion preventing layer under contaminated oil and (b) shows a case of disposing the contaminant diffusion preventing layer so as to surround contaminated soil; and

FIG. 3 is a view schematically showing a testing apparatus for evaluating a purifying ability of a contaminant diffusion preventing layer in each Example and Comparative Example.

### BEST MODE FOR CARRYING OUT THE INVENTION

First, a mixture for preventing contaminant diffusion according to the invention will be described.

The mixture for preventing contaminant diffusion according to the invention is constituted with an adsorbing agent for adsorbing a contaminant included in contaminated soil and a diluent mixed at a predetermined ratio to the adsorbing agent for adjusting permeability coefficient and thickness.

The adsorbing agent according to the invention is, as its name suggests, a material for adsorbing the contaminant included in the contaminated soil. It is not particularly limited as long as it is a material capable of effectively adsorbing the contaminant. It is preferable to contain, for example, a rare earth compound in a point that it has a high adsorptivity against the contaminant such as arsenic, fluorine or the like. Moreover, the rare earth compound is more preferable to be one or more rare earth compounds selected from cerium hydroxide (Ce(OH)₄, Ce(OH)₃), cerium oxide (CeO₂, Ce₂O₃), hydrated cerium hydroxide ((Ce(OH)₄.nH₂O, Ce(OH)₃.nH₂O), hydrated cerium oxide (CeO₂.nH₂O, Ce₂O₃.nH₂O), lanthanum hydroxide (La(OH)₃), lanthanum oxide (La₂O₃) and hydrates thereof in a point that it may have a higher adsorptivity.

Also, the adsorbing agent is preferable to contain one or more components selected from Al, Fe, Si, P, Ca and Mg. Since they are easily available components, it is possible to undertake construction inexpensively by selecting a component most suitable to the adsorbing element though the adsorptive performance is somewhat inferior as compared with the rare earth compound.

The form of the adsorbing agent is not particularly limited, but it is preferable to be fine granular, particularly granular, powdery or clayey in a point that it can be included uniformly in the mixture for preventing contaminant diffusion according to the invention to develop stable adsorption ability. At this moment, the granular form has an average particle size of 0.75 to 5 mm, the powdery form has an average particle size of 0.001 to 0.75 mm and the clayey form is a state that the powdery adsorbing agent contains approximately 50% of water.

Now, the contaminant means a component included in the contaminated soil and giving a harmful effect to human body, which is, for example, one or more components selected from arsenic, fluorine, boron, selenium, lead, chromium, cadmium, manganese, antimony and nickel.

As an example of the adsorbing agent may be used “Adcera (registered trademark)” made by Nippon Sheet Glass Co., Ltd. containing a plurality of cerium-based rare earth compounds, or “Ecomel (registered trademark)” made by Kobe Steel, Ltd. containing iron-based compounds.

The adsorptive performance of each of the above adsorbing agents is represented by immersing 1 g of each adsorbing agent in a solution containing each contaminant: arsenic, lead, hexavalent chromium, selenium, boron, mercury, fluorine and antimony with a concentration of 100 mg/l, oscillating for 24 hours, and then filtering the solution to measure each contaminant adsorbable by 1 g of the adsorbing agent as an element content (mg) by a unit of mg/g. The measurement results are shown in Table 1.

TABLE 1

| Adsorbing | Contaminant | | | | | | | |
|---|---|---|---|---|---|---|---|---|
| agent | Phosphorus | Lead | Chromium | Selenium | Antimony | Boron | Mercury | Fluorine |
| Adcera | 5 mg/g | 1 mg/g | 1 mg/g | — | 5 mg/g | — | — | 10 mg/g |
| (granular) | | | | | | | | |
| Adcera | 10 mg/g | 3 mg/g | 5 mg/g | 5 mg/g | 5 mg/g | 2 mg/g | 1 mg/g | 15 mg/g |
| (slurry) | | | | | | | | |
| Ecomel | 5 mg/g | — | — | — | — | — | — | — |

The diluent according to the invention is a material mixed at a predetermined ratio (predetermined volume ratio) to the adsorbing agent for adjusting the permeability coefficient and thickness of the mixture for preventing contaminant diffusion according to the invention. Therefore, it is not particularly limited as long as it is a material capable of adjusting the permeability coefficient and thickness. For instance, it is preferable to use an inorganic material, an inorganic fiber material, an organic material or an organic fiber material because such materials may be selected and combined from fine granules to coarse granules to adjust the water permeability of the mixture with the adsorbing agent.

The inorganic material includes, for example, diatom earth, gravel, crushed stone, sand, rubble, garden stone, glass scraps, zeolite, shell scraps, earthenware scraps, lime stone or ash such as coal ash, incineration ash or the like. The inorganic fiber material includes, for example, long-fiber or short-fiber materials such as glass fiber, alumina fiber, rock wool, slag wool, titanium fiber and the like with an aspect ratio (fiber length/fiber diameter) of 1 to 2000.

Also, the organic material includes, for example, sawdust, waste cloth, waste paper or activated carbon. The organic fiber material includes, for example, long-fiber or short-fiber materials such as aramid fiber, PET fiber and the like with an aspect ratio (fiber length/fiber diameter) of 2 to 200.

In the mixture for preventing contaminant diffusion according to the invention, the spatial velocity of water containing the contaminant is 1-60 (1/hr). When the spatial velocity in the mixture is 1-60 (1/hr), the contact time between the adsorbing agent in the mixture and the contaminant can be made to an appropriate range to thereby conduct adsorption of the contaminant sufficiently but also pass the sewage through the mixture smoothly, and as a result, excellent purifying ability can be obtained stably. At this moment, the spatial velocity of the mixture is the reciprocal of time contacting the sewage with the mixture, i.e., the sewage treating capacity of the mixture with respect to its own volume per unit time, which can be represented by the following expression:

SV=Q/V=Q/(S·h)

wherein SV is a spatial velocity (1/hr), Q is a flow rate of sewage (m³/hr), V is a volume of the mixture (m³), S is a sectional area of the mixture (m²), and h is a height of the mixture (m).

The spatial velocity of the mixture can be made to a range of 1-60 (1/hr) by adjusting the permeability coefficient and thickness thereof. Since the adsorbing agent in the mixture is small in volume and expensive in cost, it is preferable to conduct the adjustment of the permeability coefficient and thickness by mixing the adsorbing agent and the diluent at a predetermined volume ratio. The volume ratio of the adsorbing agent to the diluent is preferable to be 0.001 to 2.

When the volume ratio is less than 0.001, the ratio of the adsorbing agent becomes too large and the adsorption layer becomes too thin, and hence the contact time with the adsorbing agent can not be maintained sufficiently, and also it is difficult to form the adsorption layer at a uniform thickness and waste of the adsorbing agent occurs for maintaining the contact time, while when the volume ratio exceeds 2, the ratio of the adsorbing agent becomes too small, and it is necessary to thicken the adsorption layer depending on a component to be adsorbed and the formation of the thick adsorption layer may be difficult.

Moreover, the spatial velocity of the mixture is required to be within a range of 1-60 (1/hr) when a contaminant is not limited. Particularly, when the contaminant is specified, it is preferable that the spatial velocity is 20-40 (1/hr) in case of arsenic or antimony, 1-15 (1/hr) in case of lead or chromium, 5-20 (1/hr) in case of fluorine, 1-10 (1/hr) in case of selenium or boron, and 1-5 (1/hr) in case of mercury. Because, the adsorption and purification of each contaminant can be performed surely but also the high water permeability can be obtained.

Next, the method for preventing contaminant diffusion according to the invention will be described with reference to the drawings.

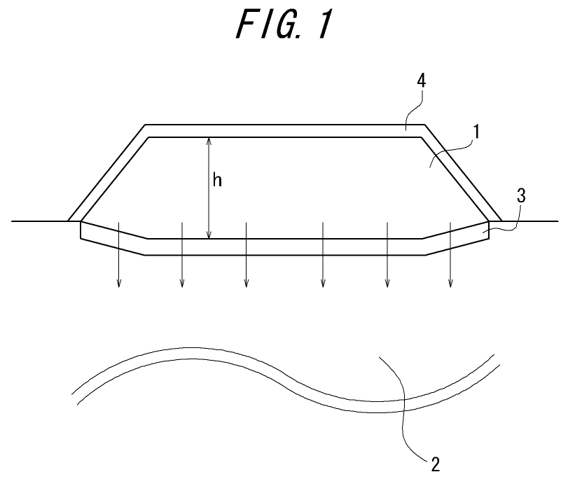

FIG. 1 is a view schematically showing a structure of soil using the method for preventing contaminant diffusion according to the invention.

The method for preventing contaminant diffusion according to the invention is a method wherein a contaminant diffusion preventing layer 3, which adsorbs a contaminant included in contaminated soil 1 and has a water permeability and a predetermined thickness, is disposed between contaminated soil 1 and non-contaminated soil 2 and the contaminant is adsorbed and held by the contaminant diffusion preventing layer 3 when sewage flowing in the contaminated soil 1 passes through the contaminant diffusion preventing layer 3.

By using the above method for preventing contaminant diffusion, it is made possible to purify water containing a contaminant discharged from the contaminated soil 1 with the contaminant diffusion preventing layer 3, so that it is possible to discharge water hardly containing the contaminant to the non-contaminated soil 2. As a result, it is an effective method in a point that the contaminated soil can be treated in the same way with normal soil without the need for mixing with a special agent or enveloping the entire soil as in the conventional method for treating contaminated soil.

Also, the contaminant diffusion preventing layer 3 is made from a mixture of an adsorbing agent for adsorbing a contaminant produced from the contaminated soil 1 and a diluent mixed at a predetermined ratio to the adsorbing agent for adjusting the permeability coefficient and thickness, and the spatial velocity of water containing the contaminant in the mixture is preferably 1-60 (1/hr). Because, when the spatial velocity is 1-60 (1/hr), stable and excellent purifying ability can be obtained as mentioned above. On the other hand, when the spatial velocity is less than 1, though excellent purifying ability can be provided, the treating capacity becomes small, and hence if the volume of water is large, the adsorption layer shows an overflow phenomenon and there is a fear that the adsorption layer serves as an impermeable layer and the water purification cannot be performed stably, while when it exceeds 60, through the treating capacity on sewage is excellent, the contact time becomes short and there is a fear that the purifying ability becomes poor.

In the contaminant diffusion preventing layer 3, it is preferable that the permeability coefficient is 1×10⁻³ to 10 cm/sec and the thickness is 0.1 to 10 m. The spatial velocity of the contaminant diffusion preventing layer 3 is determined from the permeability coefficient and the thickness h of the layer.

Furthermore, it is preferable that the contaminant diffusion preventing layer 3 is formed by mixing the adsorbing agent with the diluent and then further mixing with a diluent same as or different from the above diluent, whereby the arrangement of the adsorbing agent and the diluent is made uniform. Since the adsorbing agent and the diluent are more evenly arranged in the contaminant diffusion preventing layer 3, the stable purifying ability can be developed. As previously mentioned, the volume ratio of the adsorbing agent to the diluent is more preferably within a range of 0.001 to 2.

The content of the adsorbing agent is preferably determined based on results of the acid-added elution test and the alkali-added elution test. As described in reference literature (“Report of Sectional Meeting for Studies on Stability of Soil Treated for Insolubilization of Heavy Metals, etc.—Acid-added Elution Testing Method, Alkali-added Elution Testing Method—”, Geo-Environmental Protection Center), the acid-added elution test and the alkali-added elution test are tests wherein a sample containing the contaminant is added with a predetermined acid or alkali and agitated and filtered, and then a filtrate is examined to measure an elution amount of the contaminant. When the content of the adsorbing agent is determined based on the test results, even if the contaminant diffusion preventing layer 3 is under natural environmental change for a prolonged period or special conditions of some acid or alkali, it is possible to suppress the elution of the contaminant.

As shown in FIG. 1, it is preferable to pave the contaminated soil with asphalt or concrete to form a protection layer 4 from a point that the contaminant never contacts ambient air and the discharge to ones other than the contaminated soil can be prevented.

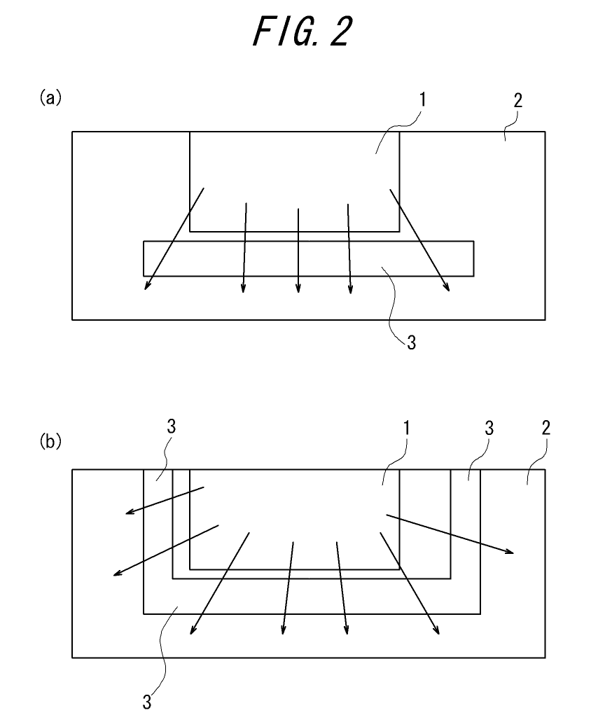

Although the above is described with respect to only one embodiment of the invention, various modifications may be made without departing from the scope of the appended claims. For example, as shown in FIGS. 2 (a) and (b), it is also possible to use the contaminant diffusion preventing layer 3 by burying it in the ground.

Now, examples of the invention will be described.

### Example 1

In Example 1, a layer for preventing contaminant diffusion is formed by mixing 50 g (specific gravity=1.2, 41.5 cm³) of a clay-like adsorbing agent (trade name “Adcera (registered trademark) (slurry)” made by Nippon Sheet Glass Co., Ltd.) comprising 30 mass % of plural cerium-based rare earth compounds, 55 mass % of water and 15 mass % of inorganic elements such as silica as a remnant with a diluent comprising 500 cm³ of glass fiber (glass short fiber with an average fiber diameter of 0.8 μm, “CMLF #208” made by Nippon Sheet Glass Co., Ltd.) and 4500 cm³ of fine sand (sand having an average particle size of 0.3 mm) at a volume ratio of 0.8:10. Since the diluent is slurry, there is used a method of mixing with the glass fiber and then further mixing with the fine sand in consideration of the mixing property. The permeability coefficient, thickness and spatial velocity of the thus formed contaminant diffusion preventing layer are shown in Table 2.

### Example 2

In Example 2, a layer for preventing contaminant diffusion is formed by mixing 50 g (specific gravity=1.2, 41.5 cm³) of a clay-like adsorbing agent (trade name as “Adcera (registered trademark) (slurry)” made by Nippon Sheet Glass Co., Ltd.) comprising 30 mass % of plural cerium-based rare earth compounds, 55 mass % of water and 15 mass % of inorganic elements such as silica as a remnant with a diluent comprising 500 cm³ of rock wool (cotton wool-like material of rock with an average fiber diameter of 4 μm, “S-fiber (registered trademark)” made by Nippon Steel Chemical Rockwool Co., Ltd.) and 500 cm³ of fine sand (sand having an average particle size of 0.3 mm) at a volume ratio of 1:1. Since the diluent is slurry, there is used a method of mixing with the rock wool and then further mixing with the fine sand in consideration of the mixing property. The permeability coefficient, thickness and spatial velocity of the thus formed contaminant diffusion preventing layer are shown in Table 2.

### Example 3

In Example 3, a layer for preventing contaminant diffusion is formed by mixing 100 g (specific gravity=0.75, 75 cm³) of a granular adsorbing agent (trade name as “Adcera (registered trademark) (granular)” made by Nippon Sheet Glass Co., Ltd.) comprising 40 mass % of plural cerium-based rare earth compounds and 60 mass % of inorganic element such as silica with a diluent comprising 1000 cm³ of sand (with an average particle size of 0.75 mm) at a volume ratio of 0.75:10. The permeability coefficient, thickness and spatial velocity of the thus formed contaminant diffusion preventing layer are shown in Table 2.

### Example 4

In Example 4, a layer for preventing contaminant diffusion is formed by mixing 100 g (specific gravity=5.1, 20 cm³) of a powdery adsorbing agent comprising an iron compound (trade name as “Ecomel (registered trademark)” made by Kobe Steel, Ltd.) with a diluent comprising 1000 cm³ of sand (with an average particle size of 0.75 mm) at a volume ratio of 0.2:10. The permeability coefficient, thickness and spatial velocity of the thus formed contaminant diffusion preventing layer are shown in Table 2.

### Example 5

In Example 5, a layer for preventing contaminant diffusion is formed by mixing 50 g (specific gravity=1.2, 41.5 cm³) of a clay-like adsorbing agent (trade name as “Adcera (registered trademark) (slurry)” made by Nippon Sheet Glass Co., Ltd.) comprising 30 mass % of plural cerium-based rare earth compounds and 55 mass % of water and 15 mass % of inorganic elements such as silica as a remnant with a diluent comprising 2400 cm³ of gravel (with an average particle size of 1.5 mm) at a volume ratio of 0.17:10. The permeability coefficient, thickness and spatial velocity of the thus formed contaminant diffusion preventing layer are shown in Table 2.

### Comparative Example 1

In Comparative Example 1, a layer for preventing contaminant diffusion is formed by mixing 100 g (specific gravity=5.1, 20 cm³) of a powdery adsorbing agent comprising an iron compound (trade name as “Ecomel (registered trademark)” made by Kobe Steel, Ltd.) with a diluent comprising 10000 cm³ of gravel (with an average particle size of 20 mm) at a volume ratio of 0.02:10. The permeability coefficient, thickness and spatial velocity of the thus formed contaminant diffusion preventing layer are shown in Table 2.

### Comparative Example 2

In Comparative Example 2, a layer for preventing contaminant diffusion is formed by mixing 50 g (specific gravity=1.2, 41.5 cm³) of a clay-like adsorbing agent (trade name as “Adcera (registered trademark) (slurry)” made by Nippon Sheet Glass Co., Ltd.) comprising 30 mass % of plural cerium-based rare earth compounds and 55 mass % of water and 15 mass % of inorganic elements such as silica as a remnant with a diluent comprising 20000 cm³ of crushed stone (with an average particle size of 5 mm) at a volume ratio of 0.02:10. The permeability coefficient, thickness and spatial velocity of the thus formed contaminant diffusion preventing layer are shown in Table 2.

### Comparative Example 3

In Comparative Example 3, a layer for preventing contaminant diffusion is formed by a diluent comprising 500 cm³ of glass fiber (glass short fiber with an average fiber diameter of 0.8 μm, “CMLF #208” made by Nippon Sheet Glass Co., Ltd.) and 4500 cm³ of fine sand (with an average particle size of 0.3 mm) without containing an adsorbing agent. The permeability coefficient, thickness and spatial velocity of the thus formed contaminant diffusion preventing layer are shown in Table 2.

### Comparative Example 4

In Comparative Example 4, a layer for preventing contaminant diffusion is formed by mixing 50 g (specific gravity=1.2, 41.5 cm³) of a clay-like adsorbing agent (trade name as “Adcera (registered trademark) (slurry)” made by Nippon Sheet Glass Co., Ltd.) comprising 30 mass % of plural cerium-based rare earth compounds and 55 mass % of water and 15 mass % of inorganic elements such as silica as a remnant with a diluent comprising 1000 cm³ of sand (with an average particle size of 0.75 mm) at a volume ratio of 0.4:10. Since the diluent is slurry, there is used a method of mixing with a small amount of the sand and then further mixing with the rest of the sand in consideration of the mixing property. The permeability coefficient, thickness and spatial velocity of the thus formed contaminant diffusion preventing layer are shown in Table 2.

### Comparative Example 5

In Comparative Example 5, a layer for preventing contaminant diffusion is formed by mixing 50 g (specific gravity=1.2, 41.5 cm³) of a clay-like adsorbing agent (trade name as “Adcera (registered trademark) (slurry)” made by Nippon Sheet Glass Co., Ltd.) comprising 30 mass % of plural cerium-based rare earth compounds and 55 mass % of water and 15 mass % of inorganic elements such as silica as a remnant with a diluent comprising 2000 cm³ of gravel (with an average particle size of 1.5 mm) at a volume ratio of 0.2:10. The permeability coefficient, thickness and spatial velocity of the thus formed contaminant diffusion preventing layer are shown in Table 2.

### Comparative Example 6

In Comparative Example 6, a layer for preventing contaminant diffusion is formed by 50 g (specific gravity=1.2, 41.5 cm³) of a clay-like adsorbing agent (trade name as “Adcera (registered trademark) (slurry)” made by Nippon Sheet Glass Co., Ltd.) comprising 30 mass % of plural cerium-based rare earth compounds and 55 mass % of water and 15 mass % of inorganic elements such as silica as a remnant. The permeability coefficient, thickness and spatial velocity of the thus formed contaminant diffusion preventing layer are shown in Table 2.

The tests are conducted with respect to the above-formed contaminant diffusion preventing layers to evaluate the performance of each contaminant diffusion preventing layer. The test method and evaluation method are shown below.

(Evaluation Method)

There is provided a contaminated soil for testing by adding 100 ml of a solution of 100 mg/l arsenic to 1 kg of commercially available Kanuma soil, mixing them and leaving it with no seal for 10 days. From the contaminated soil for testing, elution of 80% of the amount of arsenic added is observed in the elution test of the Announcement No. 46 of the Ministry of Environment, and elution of 96% and 90% are observed respectively in the acid-added test and the alkali-added test proposed by the Geo-Environmental Protection Center.

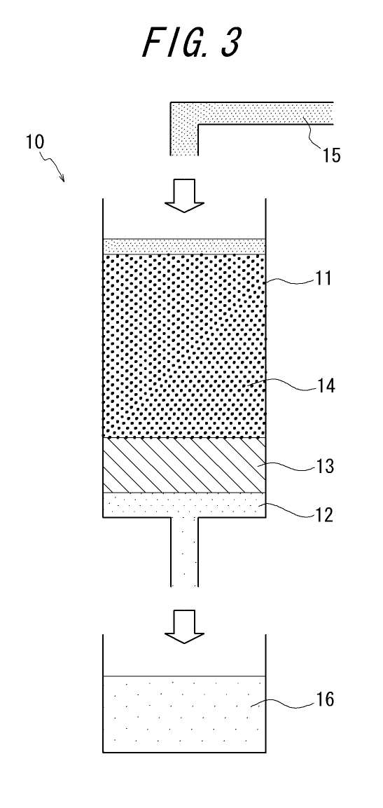

Then, a test is conducted by using a testing apparatus 10 shown in FIG. 3. In a column 11 having a sectional shape of square and a sectional area of 0.01 m² are sequentially laminated glass wool 12 for filtration, a contaminant diffusion preventing layer 13 in each of Examples and Comparative Examples, and the contaminated soil 14 for testing, and thereafter a predetermined amount of distilled water (see Table 2) is run down from the upside of the column 11 with a pump (not shown) to recover water 16 discharged from the column 11.

The arsenic concentration (mg/l) in the recovered water is measured at each of the time points after 1 hour and 24 hours while running down the distilled water, whereby the purifying ability of each contaminant diffusion preventing layer is evaluated.

TABLE 2

| | Contaminant diffusion preventing layer | | | Flow amount | Arsenic concentration in | |
|---|---|---|---|---|---|---|
| | Permeability | Thickness | Spatial velocity | of distilled | recovered water (mg/l) | |
| | coefficient (cm/sec) | (m) | (l/hr) | water (m³/hr) | After 1 hour | After 24 hours |
| Example 1 | 7.0 × 10⁻² | 0.5 | 5.04 | 0.0252 | <0.01 | <0.01 |
| Example 2 | 5.0 × 10⁻² | 0.1 | 18 | 0.018 | <0.01 | <0.01 |
| Example 3 | 1.0 × 10⁻² | 0.1 | 3.6 | 0.0036 | <0.01 | <0.01 |
| Example 4 | 2.0 × 10⁻² | 0.1 | 7.2 | 0.0072 | <0.01 | <0.01 |
| Example 5 | 4.0 × 10⁻¹ | 0.24 | 60 | 0.144 | <0.01 | <0.01 |
| Comparative | 5.0 | 1.0 | 180 | 1.8 | 0.07 | 0.05 |
| Example 1 | | | | | | |
| Comparative | 2.0 | 2.0 | 360 | 7.2 | 0.12 | 0.09 |
| Example 2 | | | | | | |
| Comparative | 7.0 × 10⁻² | 0.5 | 5.04 | 0.0252 | 0.20 | 0.13 |
| Example 3 | | | | | | |
| Comparative | 5.0 × 10⁻² | 0.1 | 0.18 | 0.0018 | <0.01 | <0.01 |
| Example 4 | | | | | | |
| Comparative | 4.0 × 10⁻² | 0.2 | 72 | 0.144 | 0.03 | 0.02 |
| Example 5 | | | | | | |
| Comparative | 3.0 × 10⁻² | 0.0075 | 144 | 0.0108 | 0.06 | 0.05 |
| Example 6 | | | | | | |

As seen from Table 2, in Examples 1 to 5, the arsenic concentration in the recovered water is small and the purifying ability of the contaminant diffusion preventing layer is high as compared to Comparative Examples 1 to 6. On the other hand, in Comparative Examples 1, 2, 5 and 6, since the spatial velocity is large, a large amount of water can be treated, but the purifying ability is low as the spatial velocity is not rationalized. In Comparative Example 3, the purifying ability is poor since the contaminant diffusion preventing layer is made from the diluent only. Also, in Comparative Example 4, the purifying ability is high likewise Examples 1 to 5, but the sewage treating ability per hour is low since the spatial velocity is too small.

According to the invention, it is possible to provide a mixture for preventing contaminant diffusion having stable and excellent purifying ability against a contaminant included in contaminated soil as compared to the conventional technique for preventing contaminant diffusion, and a method for preventing contaminant diffusion.

1. A mixture applied to a contaminated soil at a particular thickness for preventing contaminant diffusion through the soil, said mixture comprising:
an adsorbing agent for adsorbing the contaminant included in the contaminated soil; and
a diluent mixed at a predetermined ratio to the adsorbing agent for adjusting permeability coefficient and the thickness so as to achieve a spatial velocity of water containing the contaminant of 1 to 60 (1/hr).

2. The mixture for preventing contaminant diffusion according to claim 1, wherein the adsorbing agent comprises at least a rare earth compound.

3. The mixture for preventing contaminant diffusion according to claim 2, wherein the rare earth compound is one or more rare earth compounds selected from cerium hydroxide, cerium oxide, lanthanum hydroxide, lanthanum oxide and a hydrate thereof.

4. The mixture for preventing contaminant diffusion according to claim 1, wherein the adsorbing agent contains one or more components selected from Al, Fe, Si, P, Ca and Mg.

5. The mixture for preventing contaminant diffusion according to claim 1, wherein the diluent is an inorganic material, an inorganic fiber material, an organic material or an organic fiber material.

6. The mixture for preventing contaminant diffusion according to claim 1, wherein a volume ratio of the adsorbing agent to the diluent is 0.001 to 2.

7. The mixture for preventing contaminant diffusion according to claim 1, wherein the contaminant is arsenic or antimony, and the spatial velocity is 20-40 (1/hr).

8. The mixture for preventing contaminant diffusion according to claim 1, wherein the contaminant is lead or chromium, and the spatial velocity is 1-15 (1/hr).

9. The mixture for preventing contaminant diffusion according to claim 1, wherein the contaminant is fluorine, and the spatial velocity is 5-20 (1/hr).

10. The mixture for preventing contaminant diffusion according to claim 1, wherein the contaminant is selenium or boron, and the spatial velocity is 1-10 (1/hr).

11. The mixture for preventing contaminant diffusion according to claim 1, wherein the contaminant is mercury, and the spatial velocity is 1-5 (1/hr).

12. A method for preventing contaminant diffusion, which comprises:
disposing a contaminant diffusion preventing layer having a water permeability and a predetermined thickness between contaminated soil and non-contaminated soil for adsorbing a contaminant included in the contaminated soil; and,
adsorbing and holding the contaminant by the contaminant diffusion preventing layer when sewage flowing in the contaminated soil passes through the contaminant diffusion preventing layer.

13. The method for preventing contaminant diffusion according to claim 12, wherein the contaminant diffusion preventing layer comprises a mixture of an adsorbing agent for adsorbing a contaminant produced from contaminated soil and a diluent mixed at a predetermined ratio to the adsorbing agent for adjusting permeability coefficient and thickness, and wherein the contaminant is configured to be discharged from the contaminated soil into water and a spatial velocity of water containing the contaminant in the mixture is 1-60 (1/hr).

14. The method for preventing contaminant diffusion according to claim 12, wherein the contaminant diffusion preventing layer has a permeability coefficient of 1×10⁻³ to 10 cm/sec.

15. The method for preventing contaminant diffusion according to claim 12, wherein the contaminant is one or more components selected from arsenic, fluorine, boron, selenium, lead, chromium, cadmium, manganese, antimony and nickel.

16. The method for preventing contaminant diffusion according to claim 12, wherein the contaminant diffusion preventing layer is formed by mixing the adsorbing agent with the diluent and then further mixing with a another diluent same as or different from the above diluent so as to evenly arrange the adsorbing agent and the diluent and the another diluent.

17. The method for preventing contaminant diffusion according to claim 1, wherein a content of the adsorbing agent is determined based on results of an acid-added elution test and an alkali-added elution test.

18. The method for preventing contaminant diffusion according to claim 12, wherein the contaminant diffusion preventing layer has a thickness of 0.1 to 10 m.
